(19) United States
(12) Patent Application Publication
(10) Pub. No.: US 2019/0150507 A1
(43) Pub. Date: May 23, 2019

(54) ELECTRONIC CIGARETTE QUICK RELEASE CONNECTOR

(71) Applicant: Michael James Hunter, Metuchen, NJ (US)

(72) Inventor: Michael James Hunter, Metuchen, NJ (US)

(21) Appl. No.: 15/817,626

(22) Filed: Nov. 20, 2017

(51) Int. Cl. A24F 47/00; H01R 24/00; H01R 13/625

(52) U.S. Cl. CPC A24F 47/008; H01R 13/625; H01R 24/005

(57) ABSTRACT

An electronic cigarette apparatus including a first and second modules; the first removably connected to the second; wherein the first module includes a male connector, a tank, and an upper portion; wherein the second module includes a lower portion which removably connects to the upper portion of the first module to removably connect the first and second modules; and wherein the second module further includes a female connector and a battery device. The lower portion may include a top section having at least two tabs; and wherein the upper portion includes at least two slots into which the at least two tabs of the lower portion can be inserted to connect the upper and lower portions. The upper portion may include one or more ledges which assist in preventing the lower and upper portions from disconnecting, unless the upper portion is rotated with respect to the lower portion.

### FIELD OF THE INVENTION

The present invention relates to electronic cigarette devices.

### BACKGROUND OF THE INVENTION

There are known electronic quick release connectors, but they are not adequate. For example, U.S. Published Patent Application No. 20160374396A1 to Jordan et al., discloses an “E-vapor device including at least one of a bayonet connector and a connector with a knurled pattern for forming a welded junction”. However, Jordan et al., is not adequate because the connector has to be built into the device.

Magnetic connectors are known, such as disclosed at http://ezvaporizers.com/seego-conseal-pe-magnetic-adapter/prod_2511.html. These are not adequate because the magnetic connectors can be disconnected very easily and unintentionally.

### SUMMARY OF THE INVENTION

In at least one embodiment, the present invention, provides or incorporates a connector for an electronic cigarette device. The connector, in at least one embodiment, unlike prior known connectors, requires a user to turn the connector for disconnection. The connector, in at least embodiment, unlike prior known connectors, does not alter the ohms or resistance to an e-vapor device which makes it suitable for extremely low power devices up to very high power devices.

In addition, the connector of one or more embodiments of the present invention, is configured to be attached to any existing e-vapor device. In addition, in one or more embodiments, the connector also does not alter the ohms or resistance to an e-vapor device. If any part on the connector, of one or more embodiments of the present invention breaks it can be easily replaced, as opposed to other connectors such as magnetic connectors, which if they break the user will have to buy a whole new e-vapor device.

In at least one embodiment of the present application an electronic cigarette quick release connector is provided, which can be quickly connected and disconnected. In at least one embodiment the quick release connector includes two portions, an upper portion and a lower portion. The upper portion is one part and the lower portion is made up of four components. The user can connect the connector by pushing the upper portion into the lower portion and rotating clockwise until rotation stops, whereas a user may disconnect the connector by rotating the lower portion counterclockwise until the upper portion pops out of the lower portion. This is also an electrical connector, when the connector is connected it completes an electrical connection, and when the connector is disconnected the electrical connection is not complete.

The electronic quick release connector of one or more embodiments of the present invention is superior, at least, because it supports high voltage, is not limited to low power devices, does not alter ohms, can be attached to any existing connector for e-cigarettes, and cannot be unintentionally connected or disconnected.

In at least one embodiment of the present invention an electronic cigarette apparatus is provided including a first module; and a second module, wherein the first module is removably connected to the second module; wherein the first module includes a male connector, a tank, and an upper portion; wherein the second module includes a lower portion which removably connects to the upper portion of the first module to removably connect the first module to the second module; and wherein the second module further includes a female connector and a battery device.

The lower portion may include a top section having at least two tabs; and wherein the upper portion includes at least two slots into which the at least two tabs of the lower portion can be inserted to connect the upper portion with the lower portion.

The upper portion may include one or more ledges which assist in preventing the lower portion from disconnecting from the upper portion, unless the upper portion is rotated with respect to the lower portion.

The lower portion may include a bottom section into which the top section of the lower portion can be screwed in. The male connector may screw into the upper portion. The housing of the second module may be disconnected from the lower portion.

The lower portion may include an insulator and a pin. The insulator may sit in a hole of the lower portion and the pin may sit in a hole of the insulator. When the pin is in the hole of the insulator and the insulator is in the hole of the lower portion the lower portion top section is configured to be connected to the lower portion through a top thread of the top section of the lower portion and a lower portion inner thread.

In at least one embodiment, the present invention provides a method including removably connecting a first module of an electronic cigarette apparatus to a second module of the electronic cigarette apparatus; wherein the first module and the second module may be constructed as previously described.

### BRIEF DESCRIPTION OF THE DRAWINGS

FIG. 1 shows a perspective view of an apparatus in accordance with an embodiment of the present invention;

FIG. 2 shows a perspective view of the apparatus of FIG. 1 taken apart into two major sections or components;

FIG. 3 shows the apparatus of FIG. 1 taken apart into four components, with two of the components shown in a perspective view and two of the components shown from a front view;

FIG. 4 shows a top view of an upper portion which is part of the apparatus of FIG. 1;

FIG. 5 shows top, front perspective view of the upper portion of FIG. 4;

FIG. 6 shows a top, front perspective view of a lower portion 10 which is part of the apparatus of FIG. 1;

FIG. 7 shows a top, front perspective view of a lower portion top, a lower portion pin, lower a portion insulator, and a lower portion bottom;

FIG. 8 shows a top view of lower portion top shown in FIG. 7;

FIG. 9 shows a bottom view of lower portion bottom shown in FIG. 7;

FIGS. 10, 11, 12, and 13 show how a connector, which includes the lower portion and an upper portion, is locked;

FIGS. 14, 15, 16, and 17 show how the connector of FIGS. 10-13 is unlocked; and

FIG. 18 shows a bottom, front perspective view of a top portion and a bottom portion of the apparatus of FIG. 1

### DETAILED DESCRIPTION OF THE DRAWINGS

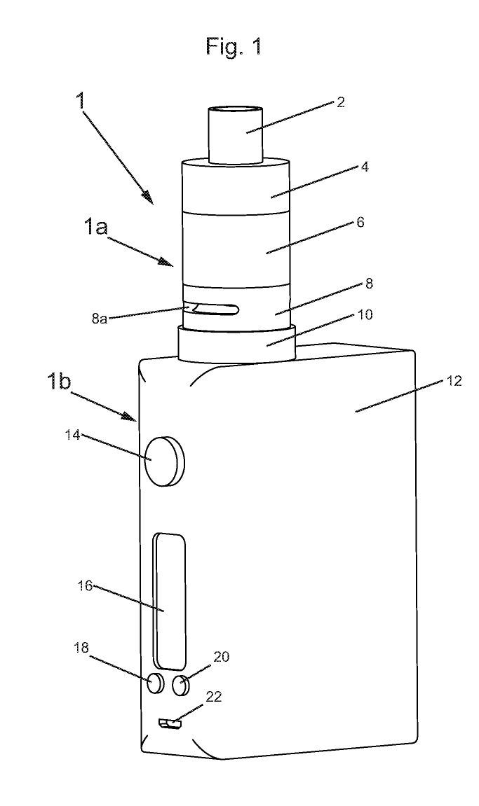

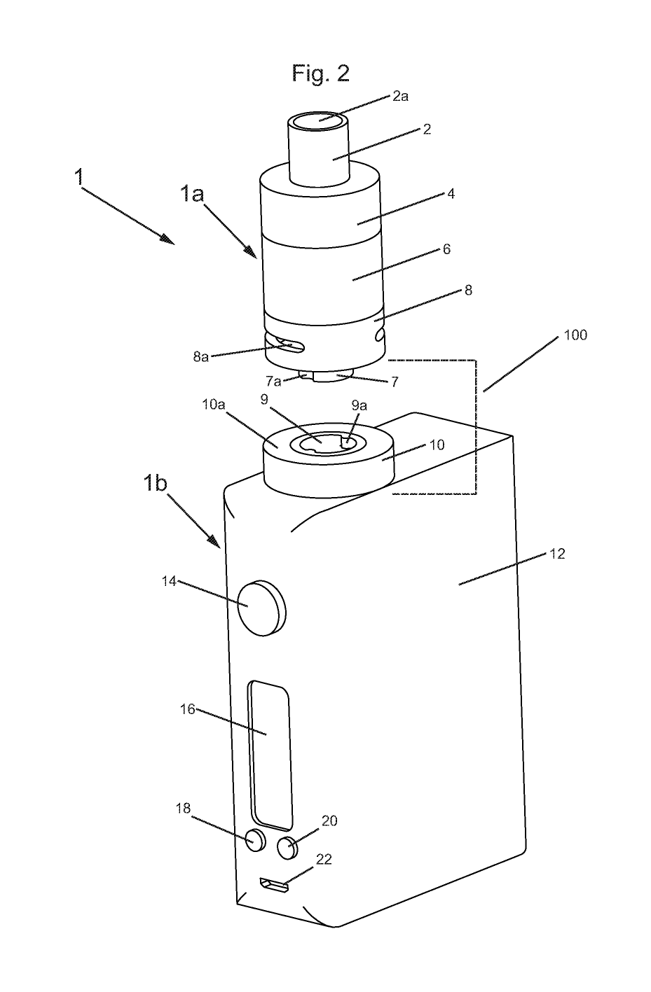

FIG. 1 shows a perspective view of an apparatus 1 in accordance with an embodiment of the present invention. FIG. 2 shows a perspective view of the apparatus 1 of FIG. 1 taken apart into section or module 1a and section or module 1b.

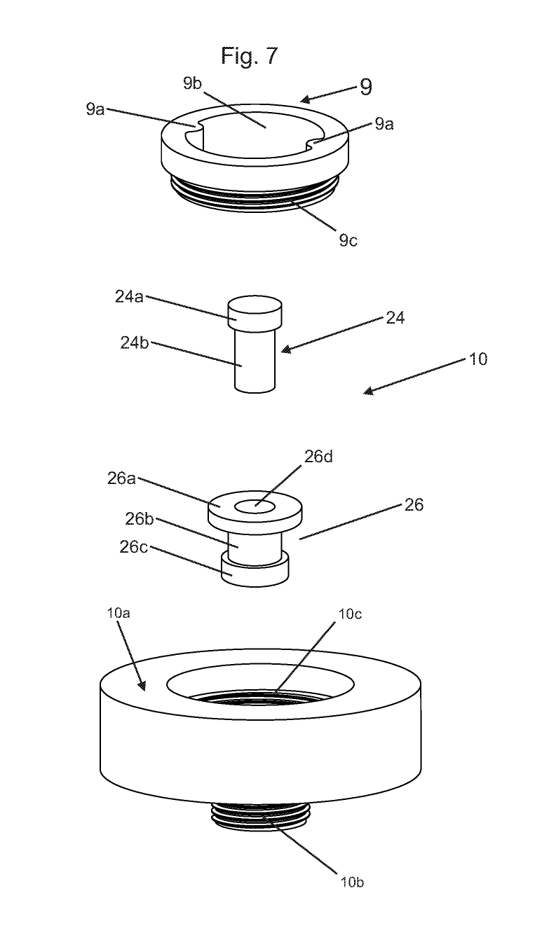

The apparatus 1 may include electronic cigarette quick release connector 100, which may include upper portion 7 and lower portion 10 shown in FIG. 2. FIG. 1 shows the apparatus 1 in a connected or assembled state with a tank module 1a and a mod or battery device module 1b connected through the connector 100 (which includes upper portion 7 and lower portion 10). In FIG. 1 a lower portion 10 can be seen whereas an upper portion 7 can not be seen. The lower portion 10 includes included four components, which is shown in more detail in FIG. 7.

Referring to FIGS. 1 and 2, the apparatus 1 includes drip tip 2, tank top 4, glass 6, tank bottom 8, lower portion 10, mod of section 1b, air intake 8a, fire button 14, screen 16, down button 18, up button 20, and charging port 22. The mod or section 1b may include batteries inside of the housing 12, which are not shown

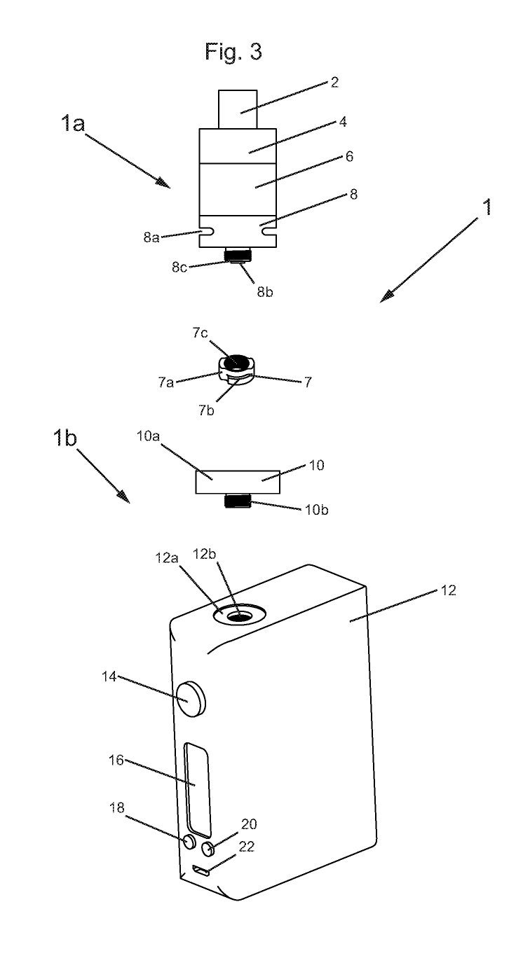

FIG. 2 is a perspective view of the apparatus 1 in a disconnected state. It shows the tank module 1a connected to an upper portion 7 and/or including the upper portion 7, and the mod module or battery device module 1b connected to and/or including the lower portion 10. How the upper 7 and lower 10 portions are connected to the rest of the tank module 1a and the rest of the mod module or battery device 1b are shown in more detail in FIG. 3.

FIG. 3 shows the apparatus 1 of FIG. 1 taken apart into four components, with two of the components shown in a perspective view and two of the components shown from a front view. FIG. 3 shows component 7. Component 7 can be inserted into section 10 and then part 8c of section 8 is inserted into component 7, in order to connect section 8 to section 10. The male connector 8c is connected to upper portion 7 through upper portion thread 7c and lower portion 10 is connected to female connector 12b through lower portion outer thread 10b so the tank module 1a can be connected to the mod module or battery device 1b through connector 100 which includes upper portion 7 and lower power 10.

The section 1b includes female connector 12, for inserting part 10b of the section 10. The section 10 includes the body portion 10a.

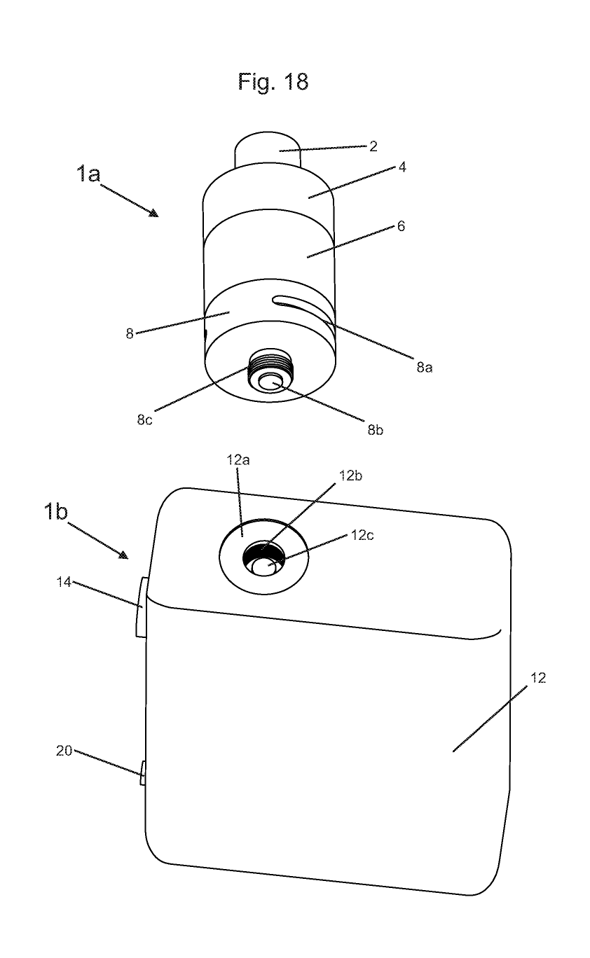

FIG. 3 is a perspective view showing how the upper 7 and lower 10 portions of connector 100 are connected to or within the tank module 1a and to or within the mod module or battery device module 1b (“mod” is an abbreviation for battery device or source of electricity). Known existing tank modules for existing electronic cigarette devices (similar or identical to 1a but not including upper portion 7) and existing known mod or battery device modules (similar or identical to 1b but not including lower portion 10 or lower portion top of section 9) are connected together through an existing threaded connector 12b,8c, which includes a male connector 8c located on the tank 1a and a female connector 12b located on the housing 12 of the mod 1b. In accordance with at least one embodiment of the present invention, the upper portion 7 is connected to the rest of the tank module 1a by being screwed onto an existing male connector 8c through an upper portion thread 7c. The lower portion 10 is connected to the rest of the mod 1b by being screwed into the existing female connector 12b shown in FIG. 18 through a lower portion outer thread 10b. In another embodiment of the present invention, the upper portion 7 may be built into the tank module 1a replacing the existing male connector 8c, and the lower portion 10 may be built into the mod module or battery device module 1b replacing the existing female connector 12b.

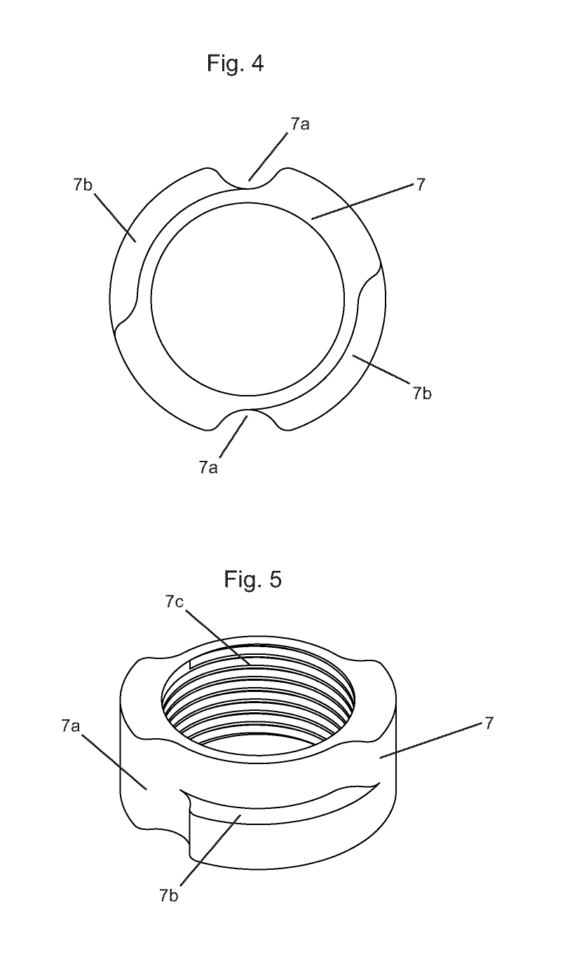

FIG. 4 shows a top view of an upper portion 7 which is part of the apparatus 1 of FIG. 1. And connector 100 of FIG. 2. FIG. 5 shows top, front perspective view of the component 7.

FIG. 4 is a top view and a perspective view of the upper portion 7. It shows all the features of the upper portion 7. The upper portion 7 includes a plurality of slots 7a, a plurality of ledges 7b, and the upper portion thread 7c seen in more detail on FIG. 5.

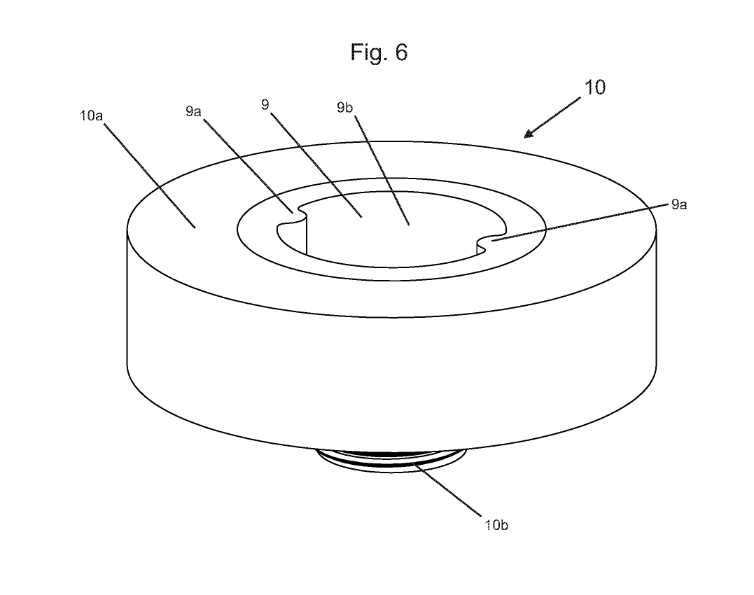

FIG. 6 is a perspective view of the lower portion 10. It shows the features and components that are visible. The lower portion 10 includes a plurality of tabs 9a, a chamber 9b, the lower portion outer thread 10b, a lower portion bottom 10a, and a lower portion top 9. The lower portion 10 also includes an insulator 26, a pin 24, a lower portion inner thread 10c, and a lower portion top thread 9c, which is shown in more detail in FIG. 7.

FIG. 7 shows a top, front perspective view of lower portion 10 which is part of the apparatus 1 of FIG. 1 and which is part of connector 100 of FIG. 2.

FIG. 7 is an exploded perspective view of the components that make up the lower portion 10. It shows how the inner components of the lower portion 10 go together. The insulator 26 sits in a lower portion hole 10d, shown in FIG. 9. The pin 24 sits in an insulator hole 26d. When the pin 24 and the insulator 26 are in place the lower portion top 9 is connected to the lower portion bottom 10a through a lower portion top thread 9c and a lower portion inner thread 10c

FIG. 7 shows a top, front perspective view of a lower portion top 9, lower portion top thread 9c, lower portion chamber 9b, tabs 9a, pin 24, pin top 24a, pin body 24b, insulator 26, insulator hole 26d, insulator top 26a, insulator body 26b, insulator bottom 26c, lower portion bottom 10a, lower portion inner thread 10c and lower portion bottom thread 10b.

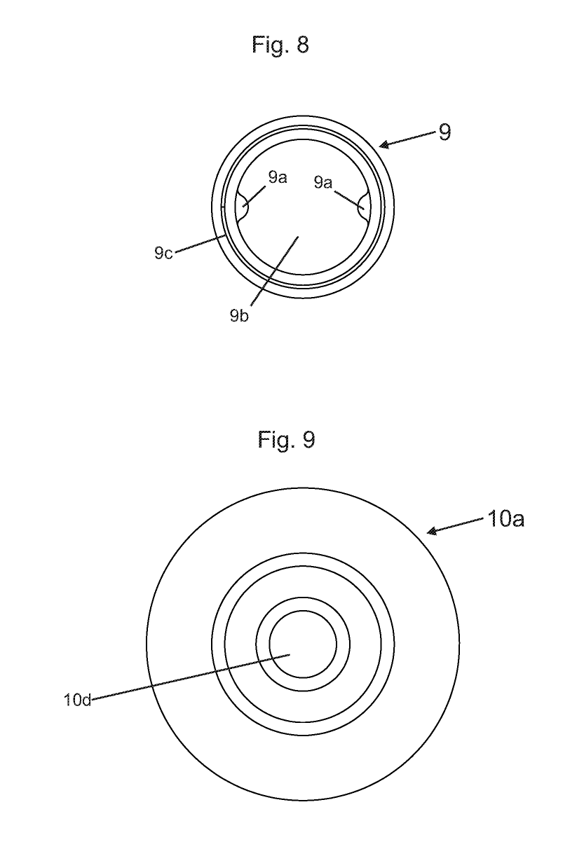

FIG. 8 is a bottom view of the lower portion top 9 and FIG. 9 is a top view of the lower portion bottom 10a. FIG. 9 is showing a more clear view of the chamber 9b and the tabs 9a, as FIG. 8 is showing a more clear view of the lower portion hole 10d. The insulator 26 sits in the lower portion hole 10d.

FIG. 8 shows a bottom view of lower portion top 9 shown in FIG. 7.

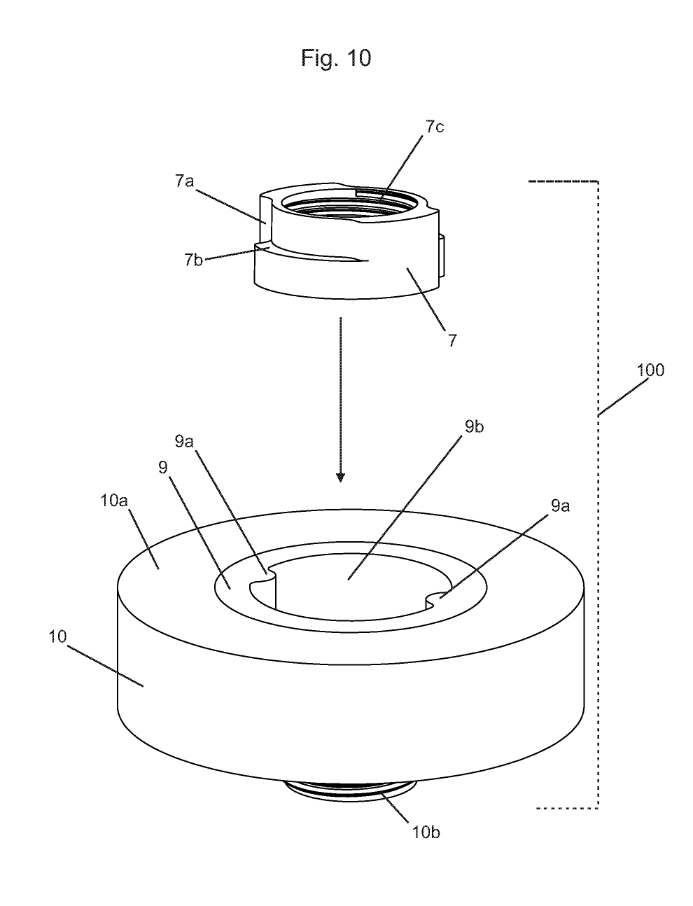

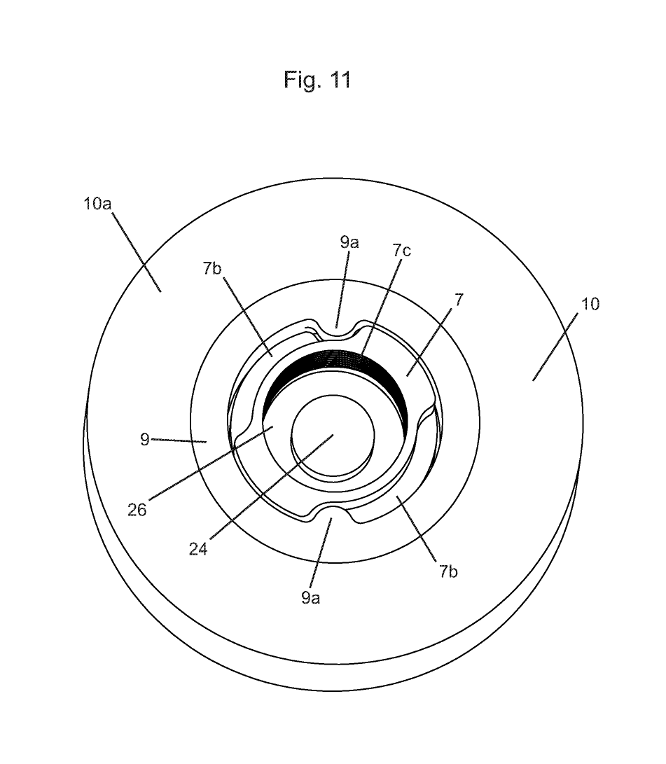

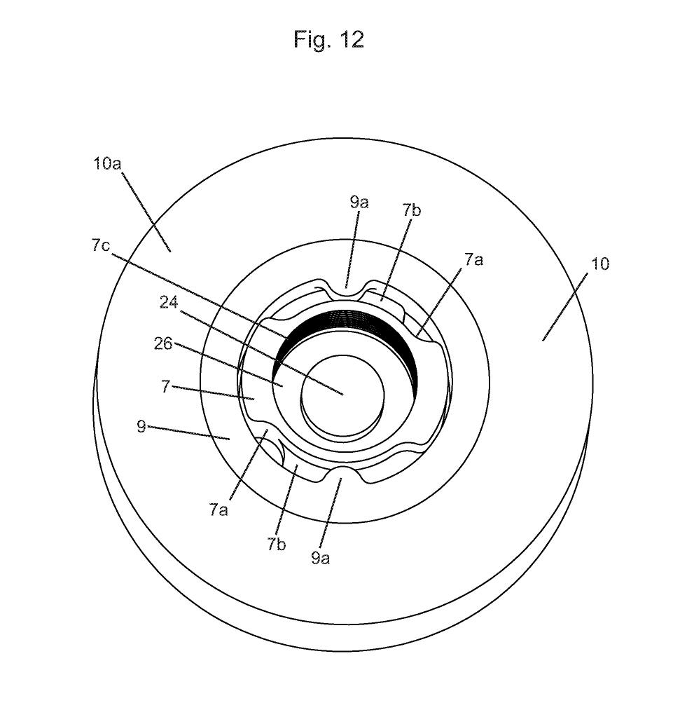

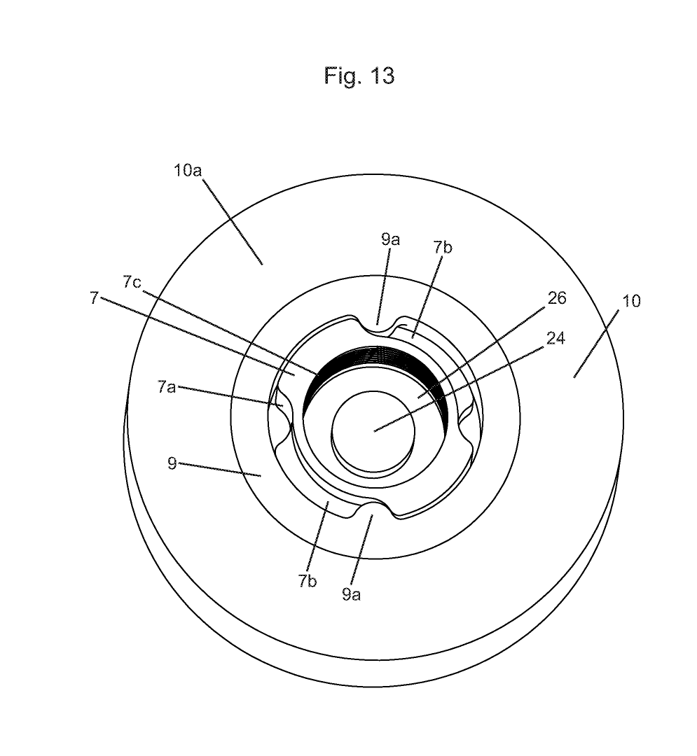

FIGS. 10-13 are perspective views showing how connector 100 (which includes upper portion 7 and lower portion 10) of the apparatus 1 is connected. FIGS. 10 and 11 show that the upper portion 7 is inserted into the chamber 9b of the lower portion 10, with the slots 7a aligned with the lower portion tabs 9a. When the upper portion 7 is being inserted into the lower portion 10, the male connector pin 8b pushes against the lower portion pin 24 which then pushes the insulator 26 allowing the upper ledge 7b to be under the lower portion tabs 9a, then the user can rotate the upper portion 7 clockwise, which is shown in more detail in FIGS. 12 and 13. FIG. 11 shows the upper portion 7 fully inserted in the chamber 9b of the lower portion 10.

FIG. 12 shows the upper portion 7 rotating clockwise with the upper ledges 7b under the lower portion tabs 9a. FIG. 13 shows connector 100 or apparatus 1 connected. It shows the lower portion tabs 9a preventing the upper portion 7 from rotating any further.

FIG. 9 shows a bottom view of lower portion bottom 10a shown in FIG. 7

FIG. 10 shows a top, front perspective view of upper portion 7 of the connector 100 of the apparatus 1. FIG. 10 shows a top, front perspective view of lower portion top 9 inserted into component 10, of connector 100 of the apparatus 1 of FIG. 1. FIG. 10 shows the upper portion 7 being inserted into the lower portion 10.

FIG. 11 shows a top view of connector 100 (which includes the upper portion 7 and the lower portion 10) being connected.

FIG. 12 shows a top view of the upper portion 7 being rotated clockwise for connection.

FIG. 13 shows a top view of the upper portion 7 and lower portion 10 fully connected. Connector 100 connected.

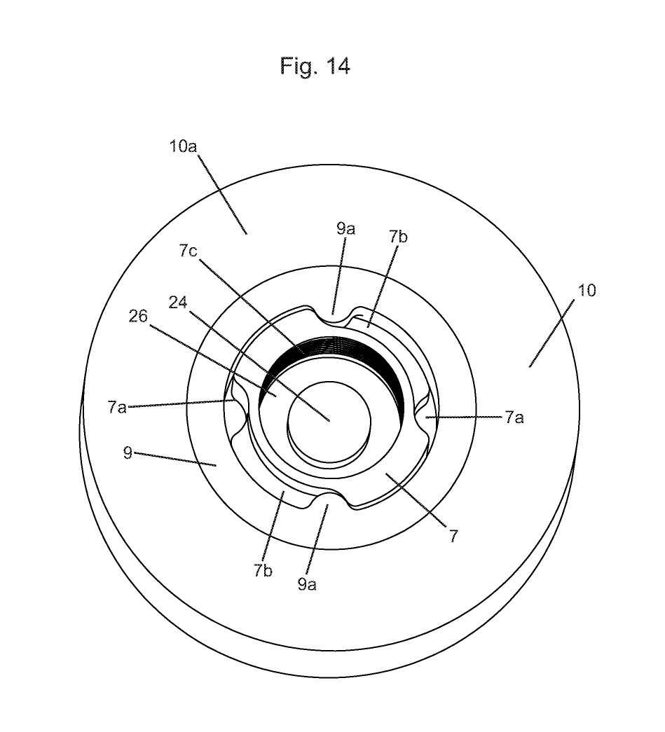

FIG. 14 shows a top view of the upper portion 7 starting to disconnect from lower portion 10.

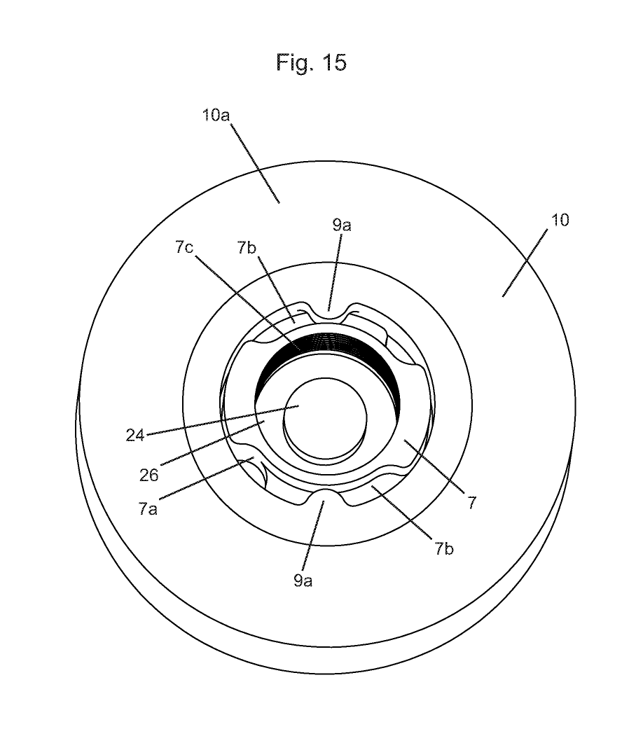

FIG. 15 shows a top view of the upper portion 7 starting to rotate counter clockwise to be disconnected from lower portion 10.

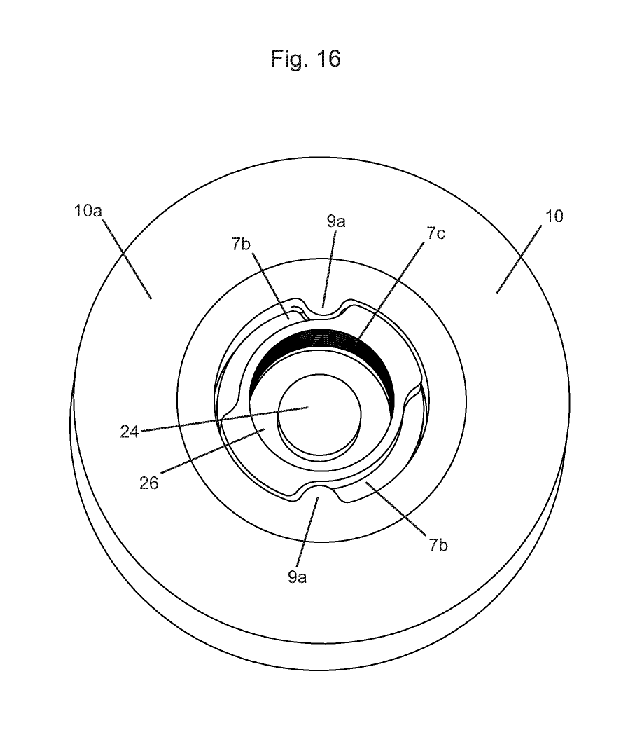

FIG. 16 shows a top view of the upper portion 7 fully rotated counter clockwise from lower portion 10. When this happens the pressure from the male connector 8c pushing down on the pin 24 will force the upper portion 7 out of the lower portion 10 causing the connector (which includes upper portion 7 and lower portion 10) to be fully disconnected.

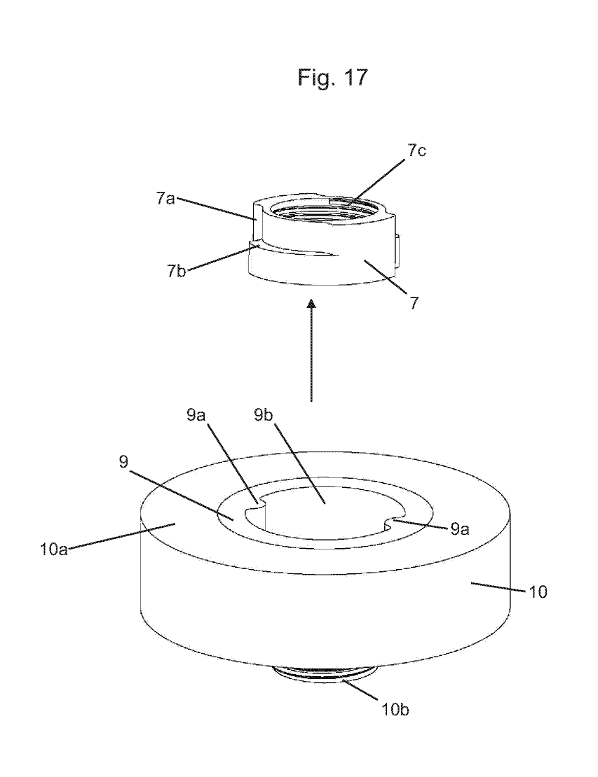

FIG. 17 shows the connector 100 (which includes upper portion 7 and lower portion 10) fully disconnected with the upper portion 7 removed from the lower portion 10.

FIG. 18 shows a bottom, front perspective view of a top portion of the apparatus 1 of FIG. 1, including sections 2, 4, 6, and 8. FIG. 18 also shows a top, front, and right perspective view of a bottom portion of the apparatus 1 of FIG. 1, including mod or section 1b, 14, and 20.

FIGS. 14 through 17 show the connector 100 (includes upper portion 7 and lower portion 10) being disconnected. FIG. 14 shows the upper portion 7 starting to rotate counterclockwise. FIG. 15 shows the upper portion 7 rotating counterclockwise. FIG. 16 shows the upper portion 7 rotated counterclockwise with the upper portion slots 7a aligned with the lower portion tabs 9a.

FIG. 17 shows the connector 100 or apparatus 1 fully disconnected. When the upper portion slots 7a are aligned with the lower portion tabs 9a, the upper portion 7 will pop out of the lower portion chamber 9b of the lower portion 10 due to the pressure of the insulator 26 being pushed down. FIG. 17 is showing the upper portion 7 out of the lower portion chamber 9b of the lower portion 10. When the upper portion 7 is separated from the lower portion 10 the connector 100 (includes 7 and 10) is disconnected as seen on FIG. 2. FIG. 18 shows the existing male connector 18c on the tank 1a and FIG. 18 shows the existing female connector 12b on the housing 12 of the mod 1b.

In alternative embodiments of the present invention the upper portion 7 can be configured to be the lower portion 10. The lower portion 10 can be configured to be the upper portion 7

Different materials, sizes, and interconnections can be used for all components. There is no limit on the amount of tabs that connect with another portion. There is no limit on the amount of slots and ledges that connect with another portion.

In one or more embodiments, the present invention may include extra components to achieve the same result such as springs, axles, hinges, buttons, clips, Velcro and switches. The tabs are not limited to the lower portion top 9 of the lower portion 10. The slots and ledges are not limited to the upper portion 7. The action of the insulator 26 when an embodiment of the present invention is being used can be substituted with springs and other materials or components that expand and contract. The lower portion 10 can be one part.

There is no limit on the amount of components that make up the lower portion 10. There is no limit on the amount of components that make up the upper portion 7. Adhesive, screws, bolts, and nails can be used to make a portion made from multiple components. One or more embodiments of the present invention are not limited to the “tank” and the “mod”. One or more embodiments of the present invention may be used for any connector used in e-cigarettes. The connector 100 (includes 7 and 10 or may consist of 7 and 10 in one or more embodiments) may be built into the tank 1a and the mod 1b replacing the original connector. The connector 100 (includes 7 and 10 in at least one embodiment) is not limited to an upper portion 7 and a lower portion 10. In at least one embodiment an alternative connector (instead of including 7 and 10) may achieve the same result with one portion.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An electronic cigarette apparatus comprising:
a first module;
a second module
wherein the first module is removably connected to the second module;
wherein the first module includes a male connector, a tank, and an upper portion;
wherein the second module includes a lower portion which removably connects to the upper portion of the first module to removably connect the first module to the second module; and
wherein the second module further includes a female connector and a battery device.

2. The electronic cigarette apparatus of claim 1 wherein
the lower portion includes a top section having at least two tabs; and
wherein the upper portion includes at least two slots into which the at least two tabs of the lower portion can be inserted to connect the upper portion with the lower portion.

3. The electronic cigarette apparatus of claim 2 wherein
the upper portion includes one or more ledges which assist in preventing the lower portion from disconnecting from the upper portion, unless the upper portion is rotated with respect to the lower portion.

4. The electronic cigarette apparatus of claim 2 wherein
the lower portion includes a bottom section into which the top section of the lower portion can be screwed in.

5. The electronic cigarette apparatus of claim 1 wherein
the male connector screws into the upper portion.

6. The electronic cigarette apparatus of claim 1 wherein
the housing of the second module can be disconnected from the lower portion.

7. The electronic cigarette apparatus of claim 2 wherein
the lower portion includes an insulator and a pin;
wherein the insulator sits in a hole of the lower portion and the pin sits in a hole of the insulator;
wherein when the pin is in the hole of the insulator and the insulator is in the hole of the lower portion the lower portion top section is configured to be connected to the lower portion through a top thread of the top section of the lower portion and a lower portion inner thread.

8. A method comprising the steps of:
removably connecting a first module of an electronic cigarette apparatus to a second module of the electronic cigarette apparatus;
wherein the first module includes a male connector, a tank, and an upper portion;
wherein the second module includes a lower portion which removably connects to the upper portion of the first module to removably connect the first module to the second module; and
wherein the second module further includes a female connector and a battery device.

9. The method of claim 8 wherein
the lower portion includes a top section having at least two tabs; and
wherein the upper portion includes at least two slots into which the at least two tabs of the lower portion can be inserted to connect the upper portion with the lower portion.

10. The method of claim 9 wherein
the upper portion includes one or more ledges which assist in preventing the lower portion from disconnecting from the upper portion, unless the upper portion is rotated with respect to the lower portion.

11. The method of claim 9 wherein
the lower portion includes a bottom section into which the top section of the lower portion can be screwed in.

12. The method of claim 8 wherein
the male connector screws into the upper portion.

13. The method of claim 8 wherein
the housing of the second module can be disconnected from the lower portion.

14. The method of claim 9 wherein
the lower portion includes an insulator and a pin;
wherein the insulator sits in a hole of the lower portion and the pin sits in a hole of the insulator;
wherein when the pin is in the hole of the insulator and the insulator is in the hole of the lower portion the lower portion top section is configured to be connected to the lower portion through a top thread of the top section of the lower portion and a lower portion inner thread.
